(19) United States
(12) Patent Application Publication
(10) Pub. No.: US 2022/0169818 A1
(43) Pub. Date: Jun. 2, 2022

(54) POLYOLEFIN-BASED RESIN FOAMED SHEET

(71) Applicant: Toray Industries, Inc., Tokyo (JP)

(72) Inventors: Hiroshi Ishida, Otsu-shi, Shiga (JP); Hideo Yogou, Otsu-shi, Shiga (JP); Tadafumi Akiyama, Otsu-shi, Shiga (JP); Yoshiyuki Oka, Otsu-shi, Shiga (JP)

(21) Appl. No.: 17/437,450

(22) PCT Filed: Mar. 5, 2020
(86) PCT No.: PCT/JP2020/009393

§ 371 Date: Sep. 9, 2021

(30) Foreign Application Priority Data
Mar. 26, 2019 (JP) 2019-058888

(51) Int. Cl. C08J 9/228; C08J 9/10; C08J 5/18; C08L 23/06

(52) U.S. Cl. CPC C08J 9/228; C08J 9/103; C08J 5/18; C08L 23/06; C08J 2201/026; C08J 2201/03; C08L 2207/066; C08J 2207/02; C08J 2323/06; C08L 2203/14; C08L 2203/20; C08L 2205/025; C08J 2203/04

(57) ABSTRACT

A polyolefin-based resin foamed sheet includes a polyolefin-based resin, wherein a thickness of the foamed sheet is 0.05-0.5 mm, a 25% compression hardness defined in JIS K6767(1999) is 20-100 kPa, a ratio of cell sizes in longitudinal and thickness directions is 9-30, a ratio of cell sizes in width and thickness directions is 9-30, and an average cell film thickness in the thickness direction of the foamed sheet is 2-7 μm.

### TECHNICAL FIELD

This disclosure relates to a polyolefin-based resin foamed sheet cross-linked and foamed with a polyolefin-based resin, in particular, a polyolefin-based resin foamed sheet excellent in compression flexibility and reworkability.

### BACKGROUND

Foamed materials such as polyolefin-based resin foamed materials are used in various applications because they have uniform and fine closed cells and have excellent cushioning property and processability. Such a foamed material can be easily thinned by stretching processing or slicing, and because it retains good cushioning property and shock absorption even in a thinned state, it is suitably used as a cushioning material in electronic/electric equipment such as mobile phones.

In particular, a foamed material of closed cells is used to improve cushioning property, shock absorption, waterproofness and the like. The foamed material is incorporated into an equipment in a state where an adhesion processing is performed on one or both surfaces thereof and this is punched or cut to about several mm. The punching is mainly carried out with a Thomson blade punching machine. To perform continuous punching, processability causing almost no punching residue is required. Since the foamed material is usually compressed in the thickness direction in a gap narrower than the thickness thereof, the foamed material is required to have a high compression flexibility. On the other hand, when assembling it into an electronic device, it is necessary to make a fine correction of the position, and a so-called rework for peeling off the foamed material attached to the equipment and sticking it again is required.

Electronic equipment are being made small-sized and thin-configuration, and foamed materials are also required to be made thinner while maintaining sufficient compression flexibility and reworkability.

To satisfy these requirements, JP-A-2018-172643 discloses making an average cell size of at least one surface layer smaller than an average cell size of an inner layer. In that method, it is mentioned that the reworkability is improved by reducing the average cell size of the surface layer, but the compatibility with compression flexibility is insufficient. Further, in WO 2015/046526, a cross-linked polyolefin-based resin foamed sheet improved with shock absorption and static electricity resistance by specifying a foaming ratio, an average cell size in each direction and a ratio thereof is described, in WO 2016/052556, a polyolefin-based resin foamed sheet improved with shock resistance and voltage resistance by specifying an average cell size and a maximum cell size in each direction, and a value of break point strength/average cell size is described, and in 4WO2016/159094, a closed cell foamed sheet capable of suppressing blurring of a liquid crystal panel (pooling) that occurs when pushing down becomes strong is described, but in any of them, reworkability is not studied.

It could therefore be helpful to provide a thin polyolefin-based resin foamed sheet improved with all of compression flexibility, reworkability and punching processability.

### SUMMARY

We thus provide:

(1) A polyolefin-based resin foamed sheet comprising a polyolefin-based resin, characterized in that a thickness of the foamed sheet is 0.05-0.5 mm, a 25% compression hardness defined in JIS K6767(1999) is 20-100 kPa, a ratio of cell sizes in longitudinal and thickness directions is 9-30, and a ratio of cell sizes in width and thickness directions is 9-30.
(2) The polyolefin-based resin foamed sheet according to (1), wherein a value of a lower one among tensile strengths in the longitudinal direction and the width direction of the foamed sheet is 5 MPa or more and 10 MPa or less.
(3) The polyolefin-based resin foamed sheet according to (1) or (2), wherein an average cell size in the thickness direction of the foamed sheet is 10-20 μm.
(4) The polyolefin-based resin foamed sheet according to any one of (1) to (3), wherein an average cell film thickness in the thickness direction of the foamed sheet is 2-7 μm.
(5) The polyolefin-based resin foamed sheet according to any one of (1) to (4), wherein a ratio of an average cell size to an average cell film thickness in the thickness direction of the foamed sheet is 2-10.
(6) The polyolefin-based resin foamed sheet according to any one of (1) to (5), wherein an average cell size averaged with average cell sizes in the longitudinal direction and the width direction of the foamed sheet is 150-500 μm.
(7) The polyolefin-based resin foamed sheet according to any one of (1) to (6), wherein an apparent density of the foamed sheet is 200-500 kg/m³.
(8) The polyolefin-based resin foamed sheet according to any one of (1) to (7), wherein a degree of cross-linking of the foamed sheet is 30-50%.
(9) The polyolefin-based resin foamed sheet according to any one of (1) to (8), wherein a thickness ratio of a skin layer of the foamed sheet is 15-30%.
(10) The polyolefin-based resin foamed sheet according to any one of (1) to (9), used to fix by adhesion a component for forming an electronic/electric equipment to a main body of the equipment.

It is thus possible to provide a polyolefin-based resin foamed sheet excellent in compression flexibility, reworkability and punching processability even if the thickness is small.

### DETAILED DESCRIPTION

Our foamed sheets will be explained in detail together with examples.

Although the polyolefin-based resin is not particularly limited, for example, exemplified is a polyethylene-based resin typified by a low-density polyethylene, a high-density polyethylene, a linear low-density polyethylene, a ultra-low-density polyethylene, or the like (the definition of density described here is as follows. ultra-low density: less than 910 kg/m³, low density: 910 kg/m³ or more and 940 kg/m³ or less, high density: greater than 940 kg/m³ and 965 kg/m³ or less), a copolymer whose main component is an ethylene, or a polypropylene-based resin typified by a homo-polypropylene, an ethylene-propylene random copolymer, an ethylene-propylene block copolymer, or the like, and further, any mixture thereof may be used.

As the above-described copolymer whose main component is an ethylene, for example, exemplified are ethylene-α-olefin copolymers obtained by copolymerization of an ethylene and an α-olefin having 4 or more carbon atoms (for example, ethylene, 1-butene, 1-pentene, 1-hexene, 4-methyl-1-pentene, 1-heptene, 1-octene and the like), an ethylene-vinyl acetate copolymers and the like.

The polyolefin-based resin is more preferably a polyethylene-based resin such as a low-density polyethylene, a linear low-density polyethylene or a ultra-low-density polyethylene, an ethylene-a-olefin copolymer or an ethylene-vinyl acetate copolymer. Further preferably, it is a low-density polyethylene, a linear low-density polyethylene, or an ethylene-α-olefin copolymer. These polyolefin-based resins may be either one or a mixture of two or more. Most preferably, it is a sole resin of a low-density polyethylene, a linear low-density polyethylene, or an ethylene-α-olefin copolymer, or a mixture thereof. As to what kind of resin composition is selected, it can be selected in accordance with the properties of the foamed sheet to be targeted, and it has deep relationships also with the production process. For example, when a resin having a strong rubber elastic behavior such as an ethylene-vinyl acetate copolymer excellent in flexibility is used, if the stress relaxation after stretching is insufficient, the resin is deformed with time passage after stretching, and a thickness unevenness called a gauge band is likely to occur on the foamed sheet wound on a roll. Therefore, it is preferable to stretch at a high temperature to secure a sufficient relaxation time. On the other hand, linear low-density polyethylene or the like can be stretched at a high stretching ratio even at a temperature near the melting point of the resin, and it becomes possible to obtain a foamed sheet excellent in tensile strength.

From the viewpoint of achieving both compression flexibility and reworkability, it is one of particularly preferable examples to use a mixture of a linear low-density polyethylene (LLDPE) and a low-density polyethylene (LDPE). When a linear low-density polyethylene and a low-density polyethylene are mixed, the ratio (ratio of parts by mass) is preferably 20:80 to 80:20. If the content of the linear low-density polyethylene resin is less than 20%, there is a possibility that the tensile strength of the foamed sheet after stretching may be reduced, which is not preferred, and if the content of low-density polyethylene resin is less than 20%, there is a possibility that the flexibility of the foamed sheet may be reduced, which is not preferred.

Further, a thermoplastic resin other than the polyolefin-based resin may be added as long as the properties of the foamed sheet are not significantly impaired. As the thermoplastic resin other than the polyolefin-based resin described here, exemplified are, in halogen-free resins, a polystyrene, acrylic resins such as a polymethylmethacrylate and styrene-acrylic acid copolymers, a styrene-butadiene copolymer, an ethylene-vinyl acetate copolymer, a polyvinyl acetate, a polyvinyl alcohol, a polyvinyl acetal, a polyvinyl pyrrolidone, petroleum resins, a cellulose, cellulose derivatives such as a cellulose acetate, a cellulose nitrate, a methyl cellulose, a hydroxymethyl cellulose and a hydroxypropyl cellulose, polyolefins such as a low-molecular-weight polyethylene, a high-molecular-weight polyethylene and a polypropylene, aromatic polyester resins such as a saturated alkyl polyester resin, a polyethylene terephthalate, a polybutylene terephthalate and a polyarylate, a polyamide resin, a polyacetal resin, a polycarbonate resin, a polyester sulfone resin, a polyphenylene sulfide resin, a polyether ketone resin, a vinyl polymerizable monomer, and a copolymer having a nitrogen-containing vinyl monomer. Further, exemplified are elastomers such as a polystyrene-based thermoplastic elastomer (SBC, TPS), a polyolefin-based thermoplastic elastomer (TPO), a vinyl chloride-based thermoplastic elastomer (TPVC), a polyurethane-based thermoplastic elastomer (TPU), a polyester-based thermoplastic elastomer (TPEE, TPC), a polyamide-based thermoplastic elastomer (TPAE, TPA), a polybutadiene-based thermoplastic elastomer (RB), a hydrogenated styrene-butadiene rubber (HSBR), block copolymers such as a styrene-ethylene butylene-olefin crystal block polymer (SEBC), an olefin crystal-ethylene butylene-olefin crystal block polymer (CEBC), a styrene-ethylene butylene-styrene block polymer (SEBS) and olefin block copolymers (OBC), and graft copolymers such as a polyolefin-vinyl-based graft copolymer, a polyolefin-amide-based graft copolymer, alpha-olefin copolymers, a polyolefin-acrylic-based graft copolymer and a polyolefin-cyclodextrin-based graft copolymer.

Further, in the resin containing a halogen, exemplified are a polyvinyl chloride, a polyvinylidene chloride, a polyvinylidene chloride ethylene trifluoride, a polyvinylidene fluoride resin, a fluorocarbon resin, a perfluorocarbon resin, a solvent-soluble perfluorocarbon resin and the like. These thermoplastic resins other than the polyolefin-based resins may be one kind or may be contained at a plurality of kinds. In particular, it is preferable to add an elastomer for the purpose of imparting compression flexibility and shock absorption, and the kind and amount are selected according to desired physical properties.

Further, as long as the desired effects are not impaired, an antioxidant such as phenol-based, phosphorus-based, amine-based or sulfur-based one, a metal deactivator, fillers such as mica and talc, a flame retardant such as bromine-based or phosphorus-based one, a flame retardant auxiliary such as antimony trioxide, an antistatic agent, a lubricant, a pigment, and an additive such as polytetrafluoroethylene, can be added.

Further, the polyolefin-based resin foamed sheet may be colored black. As the black colorant used for coloring black, for example, any of known colorants such as a carbon black (furnace black, channel black, acetylene black, thermal black, lamp black and the like), a graphite, a copper oxide, a manganese dioxide, an aniline black, a perylene black, a titanium black, a cyanine black, an activated carbon, a ferrite (non-magnetic ferrite, magnetic ferrite and the like), a magnetite, chromium oxide, an iron oxide, a molybdenum disulfide, a chromium complex, a composite oxide-based black dye, and an anthraquinone-based organic black dye, can be used. Among them, a carbon black is preferred from the viewpoint of cost and availability.

The black colorant can be used alone or in combination of two or more. The amount of the used black colorant is not particularly limited, for example, when the foamed sheet is made into a form of a double-sided adhesive sheet, it can be controlled at an appropriate amount to be able to impart a desired optical property to the seat.

The polyolefin-based resin foamed sheet has a thickness of 0.05 to 0.5 mm. More preferably, it is 0.07 mm to 0.35 mm. If the thickness of the foamed sheet is less than 0.05 mm, the compression flexibility and reworkability become insufficient. On the other hand, if the thickness exceeds 0.5 mm, in particular, when it is used for fixing parts forming an electronic/electric equipment to an equipment main body, it is not preferred because it cannot be achieved to make the electronic/electric equipment thinner.

It is necessary that the 25% compression hardness defined in JIS K6767 (1999) is 20 to 100 kPa as the compression strength. More preferably, it is 25 to 75 kPa. If the 25% compression hardness is less than 20 kPa, the compression flexibility is excellent, but the reworkability and waterproofness tend to be reduced, which is not preferred. If it exceeds 100 kPa, a large force is required when compressing the foamed sheet in the thickness direction, which makes it difficult to incorporate the foamed sheet into an equipment, which is not preferred. The compression hardness of the foamed sheet can be designed by a known method. For example, it is possible to soften the foamed sheet by using a flexible resin such as ethylene-propylene rubber, reducing the density of the foamed sheet, or adjusting the ratio of open cells. By controlling the cell shape in the thickness direction which will be described later, it becomes possible to realize a low compression hardness while having a high density.

With respect to the tensile strength of the polyolefin-based resin foamed sheet, it is preferred that a value of a lower one among tensile strengths in the longitudinal direction and the width direction is 5 MPa or more and 10 MPa or less. If it is less than 5 MPa, the reworkability is poor and there is a possibility that the foamed sheet may be broken at the work of the rework, which is not preferred, and if it exceeds 10 MPa, there is a possibility that the compression flexibility of the foamed sheet may be lowered, which is not preferred. More preferably, it is 6 MPa to 9 MPa.

The longitudinal direction means the extrusion direction in the production of the sheet before foaming (also referred to as MD direction), and the width direction means a direction perpendicular to the longitudinal direction (also referred to as TD direction).

It is necessary that the ratio of average cell sizes in the longitudinal direction and the thickness direction (also referred to as ZD direction) (average cell size in the longitudinal direction/average cell size in the thickness direction) is 9-30, and a ratio of average cell sizes in the width direction and the thickness direction (average cell size in the width direction/average cell size in the thickness direction) is 9-30. If the ratio of average cell sizes is less than 9, the compression hardness of the foamed sheet becomes greater, which is not preferred, and if it exceeds 30, it becomes difficult to make the foamed sheet thinner. More preferably, it is 10 to 25.

Further, it is preferred that an average cell size averaged with the average cell size in the longitudinal direction and the average cell size in the width direction of the foamed sheet is 150-500 μm. If the average cell size averaged with the average cell size in the longitudinal direction and the average cell size in the width direction is less than 150 μm, because the stretching of the foamed sheet is insufficient, there is a possibility that the tensile strength may be lowered, which is not preferred. If it exceeds 500 μm, because the cell is too large, there is a possibility that the shock absorption may be reduced or the waterproofness may be reduced, which is not preferred. More preferably, it is 160 to 400 μm.

It is preferred that the average cell size in the thickness direction of the polyolefin-based resin foamed sheet is 10-20 μm. If the average cell size in the thickness direction is less than 10 μm, there is a possibility that the shock absorption may be insufficient, and if it exceeds 20 μm, there is a possibility that the compression flexibility may be reduced, which are not preferred. More preferably, it is 11 to 20 μm.

It is preferred that the average cell film thickness in the thickness direction of the polyolefin-based resin foamed sheet is 2-7 μm. If the average cell film thickness is less than 2 μm, the cell film is easily broken and there is a possibility that cells are communicated to each other, which are not preferred, and if it exceeds 7 μm, there is a possibility that the compression flexibility is reduced, which is not preferred. More preferably, it is 3 to 6 μm.

It is preferred that the ratio of the average cell size to the average cell film thickness in the thickness direction of the polyolefin-based resin foamed sheet (average cell size/average cell film thickness) is 2-10. If the ratio of the average cell size to the average cell film thickness in the thickness direction is less than 2, there is a possibility that the compression flexibility of the foamed sheet is reduced, which is not preferred, and if it exceeds 10, the tensile strength tends to decrease and in addition, the waterproofness tends to decrease, which are not preferred. More preferably, it is 3 to 9.

It is preferred that the apparent density of the polyolefin-based resin foamed sheet is 200 kg/m³-500 kg/m³. If the apparent density is less than 200 kg/m³, the tensile strength of the foamed sheet is reduced, and the reworkability may be reduced or the punching processability may be reduced, which are not preferred, and if the apparent density exceeds 500 kg/m³, the foamed sheet becomes hard, and the compression flexibility may be reduced, which is not preferred. More preferably, it is 250 kg/m³-450 kg/m³.

It is preferred that the degree of cross-linking of the polyolefin-based resin foamed sheet is 30-50%. If the degree of cross-linking is less than 30%, because the thickness of the skin layer of the surface layer of the foamed sheet, which will be described later, becomes thin, there is a possibility that the punching processability may be reduced, which is not preferred. If the degree of cross-linking exceeds 50%, the compression flexibility of the foamed sheet is reduced, and in addition, the stretching processability is reduced, which are not preferred. More preferably, it is 35 to 50%.

It is preferred that the thickness ratio of the skin layer of the polyolefin-based resin foamed sheet is 15-30%. If the thickness ratio of the skin layer is less than 15%, because the strength of the surface layer is reduced, the punching processability is reduced, and in addition, the material breakage of the surface layer is likely to occur when the adhesive or the like is applied and then peeled off from the adherend, which are not preferred. On the other hand, if the thickness ratio of the skin layer exceeds 30%, the compression flexibility of the foamed sheet is reduced, and in addition, the followability to an uneven shape is also reduced, which are not preferred. More preferably, it is 15 to 25%.

It is preferred that the rate of closed cells of the polyolefin-based resin foamed sheet is 90% or more, further preferably 93% or more. If the rate of closed cells is less than 90%, there is a possibility that the tightness or the waterproofness when incorporated into an electronic equipment may be reduced, which is not preferred.

The polyolefin-based resin foamed sheet is used to fix by adhesion a component for forming an electronic/electric equipment to a main body of the equipment, by applying an adhesive to one surface or both surfaces of the foamed sheet. For that, this foamed sheet may be used as a base material for an adhesive tape. The adhesive tape is one provided with an adhesive layer on at least any one surface of the foamed sheet, and it becomes possible to adhere to the other member through the adhesive. The adhesive tape may be provided with the adhesive on both surfaces of the foamed sheet, and may be provided on one surface.

Further, the adhesive layer may be one which can form a layer of an adhesive as described above, and it may be an adhesive layer alone which is laminated on the surface of the foamed sheet or it may be an adhesive sheet which is stuck to the surface of the foamed sheet, but it is more preferable that it is an adhesive layer alone which is laminated on the surface of the foamed sheet. The double-sided adhesive sheet is one having a base material and adhesive layers provided on both surfaces of the base material. The double-sided adhesive sheet is used for adhering one adhesive layer to the foamed sheet and adhering the other adhesive layer to another member. The adhesive constituting the adhesive layer is not particularly limited and, for example, an acrylic-based adhesive, a urethane-based adhesive, a rubber-based adhesive, or the like can be used. Further, a release sheet such as a release paper may be further stuck on the adhesive. The thickness of the adhesive layer is preferably 5 to 200 μm, more preferably 7 to 150 μm.

Next, a method of producing our polyolefin-based resin foamed sheet will be explained.

The method of producing our polyolefin-based resin foamed sheet is not particularly restricted and, for example, as a preferred example, it can be produced by a production method including the following steps 1 to 4.

### Step 1

A step of supplying a polyolefin-based resin and an additive containing a thermal decomposition-type blowing agent to an extruder, melt-kneading it, and extruding it in a form of a long sheet from a die to prepare a polyolefin-based resin sheet.

### Step 2

A step of irradiating a predetermined amount of ionizing radiation to the prepared polyolefin-based resin sheet to cross-link a foamable polyolefin-based resin sheet.

### Step 3

A step of heating the cross-linked foamable polyolefin-based resin sheet and foaming the thermal decomposition-type blowing agent to prepare a foamed sheet before stretching.

### Step 4

A step of stretching the foamed sheet before stretching in any one of the longitudinal or width directions, or both directions, to obtain a polyolefin-based resin foamed sheet of a thin film.

Hereinafter, the respective steps will be explained.

### Step 1

This step uniformly kneads the polyolefin-based resin and the blowing agent and the like necessary to prepare a foamed sheet to prepare a sheet having a uniform thickness. For the kneading of the polyolefin-based resin and the blowing agent and the like, an extruder such as a single-screw extruder, a twin-screw extruder and a tandem-type extruder or a kneader mixer such as a mixing roll or a Banbury mixer can be used. Among these, it is preferred to use a twin-screw extruder because it becomes possible to control the kneadability and the resin temperature. Further, it is preferred that the twin-screw extruder is provided with a vacuum vent to prevent the generation of coarse cells by degassing, and provided with a gear pump to stabilize the thickness. Moreover, by providing a die for molding into a sheet form such as a T-die at the tip, a long sheet can be continuously produced.

The blowing agent to be used is preferably a thermal decomposition-type blowing agent that decomposes when heated at an atmospheric pressure to generate gas. As the thermal decomposition-type chemical blowing agent, for example, an organic blowing agent such as azodicarbonamide, N, N′-dinitroso pentamethylene tetramine, or P, P′-oxybenzene sulfonyl hydrazide, and an inorganic blowing agent such as sodium bicarbonate, ammonium carbonate, ammonium bicarbonate or calcium azide, can be exemplified. The blowing agent can be used alone or in combination of two or more kinds. To obtain a foamed sheet flexible and having a smooth surface, an atmospheric pressure foaming method using azodicarbonamide as the blowing agent is preferably used.

### Step 2

This step irradiates a predetermined amount of ionizing radiation to the polyolefin-based resin foamed sheet prepared in step 1 to cross-link the resin. As the ionizing radiation, for example, α-rays, β-rays, γ-rays, electron beams and the like can be exemplified. Although the irradiation dose of the ionizing radiation varies depending upon the target degree of cross-linking, the shape, the thickness of the object to be irradiated or the like, the irradiation dose is usually 1 to 20 Mrad, preferably 1 to 10 Mrad. If the irradiation dose is too small, because the cross-linking does not proceed sufficiently, the effect is insufficient, and if it is too large, there is a possibility that the resin may be decomposed, which is not preferred. Among these, an electron beam is preferable because the resin can be efficiently cross-linked for the irradiated objects having various thicknesses by controlling the electron acceleration voltage. Its acceleration voltage is preferably 200-1,000 kV. If the acceleration voltage is low, the degree of cross-linking on the non-irradiated surface side may be insufficient, and on the contrary, if the acceleration voltage is high, there is a possibility that the degree of cross-linking on the irradiated surface side may be insufficient. Further, the irradiation times of the ionizing radiation is not particularly restricted. If the degree of cross-linking is too high, the foamed sheet becomes hard, and on the contrary, if the degree of cross-linking is too low, the thickness ratio of a skin layer decreases and the punching processability tends to reduce.

Further, at this time, to adjust the cross-linking of the resin, in addition to controlling the irradiation dose of ionizing radiation, the adjustment is possible also by compounding a polyfunctional monomer such as divinylbenzene or 1,6-hexanediol dimethacrylate in advance.

### Step 3

This step heats the foamable polyolefin-based resin sheet prepared in step 2 to obtain a foamed sheet before stretching. As the heating method, a conventionally known method can be used and, for example, it can be carried out in a vertical or horizontal hot air faming furnace, or a chemical bath such as a molten salt. Accompanying with the decomposition of the thermal decomposition-type blowing agent, because the sheet is foamed, and for the purpose of removing a slack thereof and the like, by stretching the sheet in the longitudinal direction or the width direction, it becomes possible to prepare a foamed sheet having a desired thickness. At this time, it is possible to adjust the cell shape of the foamed sheet by stretching in the longitudinal direction or the width direction, and it becomes possible to control the final cell shape in the foamed sheet described later. The average cell size in the longitudinal direction and the width direction of the foamed sheet before stretching is preferably 100 to 200 μm. If the average cell size in the longitudinal direction and the width direction of the foamed sheet before stretching is less than 100 μm, the average cell size in the longitudinal direction and the width direction of the foamed sheet after stretching does not become 150 μm or more, and the average cell size in the thickness direction also does not fall in the range of 10 to 20 μm, which are not preferred.

### Step 4

This step stretches the foamed sheet before stretching prepared in step 3 to prepare a foamed sheet of a thin film having a desired thickness. Although the stretching can be carried out in any one of the longitudinal direction and the width direction or in both directions to obtain the foamed sheet, from the viewpoint of improving the uniformity of the properties and the tensile strength, it is preferred to carry out the stretching in both directions. Further, when stretched in both the longitudinal direction and the width direction, either sequential stretching or simultaneous stretching may be employed. Furthermore, it is possible to carry out this step by any one of a method continuously followed from step 3, and a method in which a foamed sheet before stretching is prepared in step 3, then cooled once, and after being wound up, the foamed sheet before stretching is heated again and stretched.

The higher the stretching ratio is, because the cells are more stretched in the longitudinal direction and the width direction, the average cell size in the longitudinal direction and the width direction becomes larger, and the average cell size in the thickness direction becomes smaller. Further, the thickness of the cell film also becomes smaller, the compression flexibility is improved and, in addition, the tensile strength is increased because the resin is oriented, and therefore, the reworkability is improved. On the other hand, if it is too high, the average cell size in the thickness direction becomes too small, in addition that there is a possibility that the shock absorption addition may be reduced, the sheet is easily broken at the time of the stretching processing and, therefore, such a condition is not preferred. From such a point of view, the stretching ratio is preferably 150-250% in each of the longitudinal direction and the width direction, and most preferably 175-225%.

Furthermore, the temperature at which the stretching processing is performed is also very important. If the stretching temperature is high, because the strength of the cell film portion is relatively low, the force for the cells to become spherical is large, the cells in the foamed sheet after stretching tend to have a large cell size in the thickness direction. If the stretching temperature is low, because the strength of the cell film portion is relatively high, the cell shape in the stretched state tends to be maintained. Therefore, to control the average cell size in the thickness direction of 10-20 μm and the average thickness of cell film to 2-7 μm, it is preferred to perform the stretching in the range of the melting point of the resin forming the foamed sheet before stretching ±25° C. When composed of a plurality of resins, the melting point calculated by weighted average is used.

Thus, to control the ratio and temperature of stretching in detail, it is one of the preferred examples that the step 3 of preparing the foamed sheet before stretching and the step 4 of making the foamed sheet by stretching the foamed sheet of the step 3 are carried out independently. It becomes also possible to independently control the speed at which the blowing agent is decomposed to prepare a foamed sheet before stretching in step 3 and the speed at which the foamed sheet is stretched in step 4. Further, in such a manner, by performing the slicing of dividing the foamed sheet before stretching prepared in the step 3 in the thickness direction and thinning it, and thereafter, performing the stretching in the step 4, it becomes possible to make the foamed sheet further thinner.

Although the use of the polyolefin-based resin foamed sheet is not particularly limited, for example, it is preferably used inside an electronic device. Since the polyolefin-based resin foamed sheet is a thin film, it can be suitably used inside a thin electronic device, for example, various portable electronic devices. As the portable electronic devices, exemplified are a notebook-type personal computer, a mobile phone, a smartphone, a tablet, a portable music device and the like. This foamed sheet can be used, inside the electronic devices, as a shock absorption material for absorbing a shock, a sealant for filling a gap between members and the like.

### EXAMPLES

Hereinafter, our foamed sheets will be described in more detail with reference to examples, but this disclosure is not limited to these examples. Polyolefin-based resin foamed sheets of a plurality of types of Examples and Comparative Examples, which will be described later, were prepared, and the physical properties and the like were measured and the performances and the like were evaluated. First, the measurement and evaluation methods will be explained.

### (1) Thickness

The thickness of a foamed sheet was measured according to ISO1923 (1981) “Measurement method of foamed plastics and rubber—Determination or linear dimensions.” Concretely, using a dial gauge equipped with a circular probe having an area of 10 cm², a foamed sheet cut to a certain size is stationarily placed on a flat table, and the thickness is measured at a condition of contacting the probe with the surface of the foamed sheet from above at a constant pressure of 10 g.

### (2) Apparent Density

The apparent density of a foamed sheet is a value measured and calculated according to JIS K6767 (1999) “Cellular plastics-Polyethylene-Methods of test.” The thickness of a test piece of the foamed sheet cut into an area of 10 cm² is measured, and the mass of this test piece is weighed. The value obtained by the following equation is defined as an apparent density, and the unit is kg/m³:

apparent density (kg/m³)={mass of test piece (kg)/area of test piece 0.01 (m²)/thickness of test piece (m)}.

### (3) Degree of Cross-Linking

The degree of cross-linking of the foamed sheet is determined as follows. The foamed sheet is cut into about 0.5 mm square and about 100 mg is weighed with an accuracy of 0.1 mg. After immersing it in 200 ml of tetralin at a temperature of 140° C. for 3 hours, the mixture is naturally filtered through a 100 mesh stainless steel wire mesh, and the insoluble matter on the wire mesh is dried in a hot air oven at 120° C. for 1 hour. Then, it is cooled in a desiccator containing silica gel for 30 minutes, the mass of this insoluble matter is precisely weighed, and the degree of cross-linking of the foamed sheet is calculated as a percentage according to the following equation:

degree of cross-linking (%)={mass of insoluble matter (mg)/mass of weighed foamed sheet (mg)}×100.

### (4) Rate of Closed Cells

The rate of closed cells of the foamed sheet can be determined as follows in detail.

First, a planar square-shaped test piece having a side of 5 cm is cut out from the foamed sheet. Then, the thickness of the test piece is measured to calculate the apparent volume V1 of the test piece, and the weight W1 of the test piece is measured.

Next, the volume occupied by cells V2 is calculated based on the following equation. The density of the matrix resin forming the test piece is referred to as ρ (g/cm³).

Volume occupied by cells V2=V1−W1/ρ

Subsequently, the test piece is immersed in distilled water controlled at 23° C. at a depth of 100 mm from the water surface, and a pressure of 15 kPa is applied to the test piece for 3 minutes. Thereafter, the test piece is released from pressurization in water, and after being left stationarily as it is for 1 minute, the test piece is taken out from the water to remove the water adhering to the surface of the test piece, the weight W2 of the test piece is measured, and the rate of open cells F1 and the rate of closed cells F2 are calculated based on the following equations:

Rate of open cells F1 (%)=100×(W2−W1)/V2

Rate of closed cells F2 (%)=100−F1.

### (5) Thickness Ratio of Skin Layer

The thickness ratio of skin layer of the foamed sheet is calculated as follows.

The cross section of the foamed sheet was observed with a scanning electron microscope (SEM) (supplied by Hitachi High-Technologies Corporation, S-3000N) at a magnification of 1000 times, and the obtained image and measurement software were used for measurement. The distance from the surface of the foamed sheet to the part present with cells was defined as the thickness of skin layer. The ratio of the thickness of skin layer to the thickness of the foamed sheet was defined as the thickness ratio of skin layer.

### (6) Average Cell Size

The average cell size of the foamed sheet is calculated as follows. The cross section of the foamed sheet was observed at a magnification of 50 times using a scanning electron microscope (SEM) (supplied by Hitachi High-Technologies Corporation, S-3000N), and using the obtained image and measurement software, the cell size (diameter) was measured. The cell size was measured as the maximum length of each cell in the direction along each of MD direction, TD direction and ZD direction within a range of 1.5 m×1.5 mm in the image of the cross section taken at the above-described magnification in the direction along each of the sheet extrusion direction (longitudinal direction of the sheet: MD direction), the direction perpendicular to the extrusion direction (width direction of the sheet: TD direction), and the thickness direction (ZD direction), and the average cell size in each direction was calculated from 30 randomly selected measurement results. The cell size in the thickness direction (ZD direction) can be measured from an image of a cross section in either the MD direction or the TD direction, but in the respective Examples described later, the image of the cross section in the MD direction was used for the measurement.

### (7) Ratio of Cell Sizes

The ratio of cell sizes of the foamed sheet was calculated from the ratio between the average cell sizes in the MD direction, the TD direction, and the ZD direction measured in (6).

### (8) Cell Film Thickness

The cell film thickness of the foamed sheet is calculated as follows. The cross section of the foamed sheet was observed at a magnification of 1,000 times using a scanning electron microscope (SEM) (supplied by Hitachi High-Technologies Corporation, S-3000N), and using the obtained image and measurement software, the cell size (diameter) was measured. A foamed sheet has a large number of cells that are bubbles, and adjacent cells are separated from each other by a cell membrane. The cell film thickness was calculated from 10 randomly selected measurement results by measuring the distance between cells adjacent to each other in the thickness direction (ZD direction).

### (9) Method of Measuring Melting Point of Resin

The melting point of the used resin composition is measured in accordance with JIS K7121(1987) “Testing Methods for Transition Temperatures of Plastics.” Concretely, using a DSC (Differential Scanning calorimeter), heating was carried out at a heating rate of 10° C./min up to a temperature higher by about 30° C. than that at the end of the melting peak, a curve was drawn, and the number at the peak top was read.

### (10) Compression Hardness

The method of measuring 25% compression hardness as a compressive strength is in accordance with JIS K6767 (1999) “Cellular plastics-Polyethylene-Methods of test.” As the measuring device, the Tensilon universal testing machine UCT-500 supplied by Orientec Co., Ltd. is used here.

### (11) Tensile Strength

Using a punching blade of dumbbell shape No. 1 defined in JIS K6251: 2010, the foamed sheet was punched in the flow direction (MD direction: extrusion direction) of the foamed sheet to obtain five test pieces. The foamed sheet was punched in the width direction (TD direction: the direction perpendicular to the extrusion direction) to obtain five test pieces.

After conditioning the test pieces under a standard atmosphere at a temperature of 23° C. and a relative humidity of 50% for 16 hours or more, the measurement was carried out under the same standard atmosphere. The measurement was carried out at a distance between grippers of 50 mm and a test speed of 500 mm/min, and calculation was carried out by the method defined in JIS K6251: 2010. However, the elongation was calculated from the distance between the grippers. The tensile strength TS (MPa) is calculated by the following equation:
TS=Fm/Wt
TS: tensile strength (MPa)
Fm: maximum force (N)
W: length of parallel part of punching blade shape (mm)
t: thickness of test piece (mm).

As the measuring device, a Tensilon universal testing machine UCT-500 supplied by Orientec Co., Ltd. was used here.

### (12) Dropping Ball Shock Strength

### Manufacturing of Test Device

A double-sided adhesive tape was produced by applying an acrylic-based adhesive to both sides of the foamed sheet. The obtained double-sided adhesive tape was punched into a square having an outer dimension of 24.6 mm and an inner dimension of 20.6 mm to prepare a frame-shaped test piece having a width of 2 mm. After sticking one surface of the test piece to a square SUS plate with a thickness of 2 mm and a side of 24.6 mm, the other surface of the test piece was stuck to a square SUS plate with a side of 200 mm and opened with a square hole with a size of 20.0 mm on the central portion, and a force of 62 N was applied for 10 seconds to press-attach the SUS plates located above and below and the test piece to each other, and it was left at 23° C. for 48 hours to prepare a test device.

### Determination of Dropping Ball Shock Resistance

The prepared test device was fixed to a support base, and an iron ball sized to pass through the square hole was dropped to pass through the square hole. The weight of the iron ball and the height for dropping the iron ball were gradually changed, and by the shock applied by dropping the iron ball, the dropping ball shock strength, when the test piece and the SUS plate were peeled off from each other, was measured. As the dropping ball shock tester, a dropping ball-type shock tester IM-301 supplied by Tester Sangyo Co., Ltd. was used here.

### (13) Evaluation of Reworkability

A tape having a thickness of 30 μm coated with an acrylic-based adhesive on the foamed sheet was prepared, and punching was performed to a size of a width of 5 mm and a length of 100 mm. The prepared adhesive sheet was placed on a SUS plate, it was pressed onto the SUS plate three times with a 2 kg roller, and after it was left at 23° C. for 20 minutes to be stuck, the quality, when it was peeled off, was visually determined according to the following criteria:

◯: The foamed sheet does not break, does not elongate, and can be used again.
x: The foamed sheet breaks or elongates.

### (14) Evaluation of Punching Processability

The foamed sheet was processed to be punched at a size of a width of 100 mm and a length of 100 mm. The prepared foamed sheet was placed on a polyethylene plate having a thickness of 10 mm, and punching was performed to a width of 1 mm using a punching machine with a Thomson blade. After punching 100 sheets, the quality, when punching residue on the polyethylene plate was observed, was visually determined according to the following criteria:

◯: Punching Residue almost does not remain on the polyethylene plate.
x: Many punching residues remain on the polyethylene plate.

### Example 1

50 parts by mass of a linear low-density polyethylene (LLDPE) (density: 925 kg/m³, MFR (Melt Flow Rate): 0.8 g/10 minutes, melting point: 122° C., “Nipolon” F15R (registered trademark), supplied by Tosoh Corporation), 50 parts by mass of a low-density polyethylene (LDPE) (density: 924 kg/m³, MFR: 2.0 g/10 minutes, melting point: 110° C., “Petrosen” 183 (registered trademark), supplied by Tosoh Corporation), 2.8 parts by mass of azodicarbonamide which is a thermal decomposition-type blowing agent, and 0.1 part by mass of a phenol-based antioxidant (“IRGANOX” 1010 (registered trademark), supplied by BASF Japan Corporation) were supplied to an extruder and melt kneaded at 130° C. A foamable composition prepared by kneading the supplied respective components was extruded from the extruder to obtain a foamable sheet with a thickness of 0.50 mm. Next, at an acceleration voltage of 800 kV, an electron beam with a predetermined amount of absorbed dose was irradiated to the foamable sheet from both surface sides to achieve a degree of cross-linking described in Table 1 to obtain a cross-linked foamable sheet. The cross-linked foamable sheet was continuously fed into a foaming furnace maintained at 240° C. by an infrared heater for the upper surface and a salt bath for the lower surface to heat and foam the sheet to obtain a foamed sheet before stretching. Then, after cooling once, a foamed sheet was obtained by stretching it was stretched at conditions of an MD stretching roll temperature of 105° C., a TD tenter temperature of 125° C., an MD stretching ratio of 200% and a TD stretching ratio of 190% so that the total thickness became the thickness shown in Table 1 to obtain a foamed sheet. The obtained foamed sheet was evaluated according to the above-described evaluation methods. The results are shown in Table 1.

### Examples 2-12

Foamed sheets were prepared in the same manner as that in Example 1 other than conditions where the compositions of polyolefin resins and azodicarbonamide, and the thicknesses of foamable sheets, the thicknesses of foamed sheets before stretching, the absorbed doses of electron beam, the MD stretching ratios, the TD stretching ratios and the like were set as shown in Table 1. Further, in Examples 11 and 12, as a olefin block copolymer (OBC), “INFUSE” (registered trademark) 9507 supplied by Dow Chemical Company (density: 867 kg/m³, MFR: 5.0 g/10 minutes, melting point: 119° C.) was used.

### Comparative Examples 1-9

Foamed sheets were prepared in the same manner as that in Example 1 other than conditions where the compositions of polyolefin resins and azodicarbonamide, and the thicknesses of foamable sheets, the thicknesses of foamed sheets before stretching, the absorbed doses of electron beam, the MD stretching roll temperatures, the TD stretching tenter temperatures, the MD stretching ratios, the TD stretching ratios and the like were set as shown in Table 2. The results are shown in Table 2.

### Comparative Example 10

A foamed sheet was prepared in the same manner as that in Example 1 other than a condition where after a foamed sheet was obtained, only an MD stretching was performed.

### Comparative Example 11

A foamed sheet was prepared in the same manner as that in Example 1 other than a condition where after a foamed sheet was obtained, an MD stretching and a TD stretching were not performed.

TABLE 1

| | | | | Example | | | | | | | | | | | |
|---|---|---|---|---|---|---|---|---|---|---|---|---|---|---|---|
| | Item | | Unit | 1 | 2 | 3 | 4 | 5 | 6 | 7 | 8 | 9 | 10 | 11 | 12 |
| Resin | LLDPE | | (—) | 50 | 50 | 50 | 50 | 50 | 50 | 50 | 50 | 70 | 30 | 45 | 40 |
| composition | LDPE | | (—) | 50 | 50 | 50 | 50 | 50 | 50 | 50 | 50 | 30 | 70 | 45 | 40 |
| | OBC | | (—) | 0 | 0 | 0 | 0 | 0 | 0 | 0 | 0 | 0 | 0 | 10 | 20 |
| Condition | Thickness of foamed | | (mm) | 0.50 | 1.40 | 0.50 | 0.50 | 0.50 | 0.50 | 0.60 | 0.35 | 0.50 | 0.50 | 0.50 | 0.50 |
| of | sheet before stretching | | | | | | | | | | | | | | |
| stretching | Temperature of MD | | (° C.) | 105 | 105 | 105 | 105 | 105 | 105 | 105 | 105 | 105 | 105 | 105 | 105 |
| | stretching roll | | | | | | | | | | | | | | |
| | Temperature of TD | | (° C.) | 125 | 135 | 125 | 125 | 125 | 125 | 125 | 125 | 125 | 125 | 125 | 125 |
| | stretching tenter | | | | | | | | | | | | | | |
| | MD stretching ratio | | (%) | 200 | 200 | 200 | 200 | 200 | 150 | 220 | 170 | 200 | 200 | 200 | 200 |
| | TD stretching ratio | | (%) | 190 | 190 | 250 | 190 | 190 | 250 | 210 | 160 | 190 | 190 | 190 | 190 |
| Properties | Thickness | | (mm) | 0.10 | 0.30 | 0.07 | 0.10 | 0.10 | 0.10 | 0.10 | 0.10 | 0.10 | 0.10 | 0.10 | 0.10 |
| of foamed | Density | | (kg/m³) | 430 | 400 | 450 | 250 | 430 | 440 | 250 | 300 | 420 | 410 | 430 | 430 |
| sheet | Degree of cross-linking | | (%) | 35 | 35 | 35 | 35 | 48 | 35 | 32 | 35 | 29 | 38 | 35 | 35 |
| | Rate of closed cells | | (%) | 95 | 95 | 95 | 95 | 95 | 95 | 95 | 95 | 95 | 95 | 95 | 95 |
| | Thickness ratio of skin layer | | (%) | 20 | 20 | 17 | 15 | 24 | 20 | 13 | 19 | 16 | 21 | 20 | 20 |
| | Average | MD | (μm) | 250 | 260 | 250 | 280 | 190 | 220 | 310 | 240 | 270 | 230 | 250 | 250 |
| | cell size | TD | | 180 | 190 | 230 | 210 | 120 | 230 | 230 | 200 | 190 | 170 | 180 | 180 |
| | | ZD | | 18 | 20 | 12 | 20 | 11 | 18 | 19 | 22 | 19 | 17 | 20 | 20 |
| | | Average of | | 215 | 225 | 240 | 245 | 155 | 225 | 270 | 220 | 230 | 200 | 215 | 215 |
| | | MD and TD | | | | | | | | | | | | | |
| | Ratio of cell | MD/ZD | (—) | 13.9 | 13.0 | 20.8 | 14.0 | 17.3 | 12.2 | 16.3 | 10.9 | 14.2 | 13.5 | 12.5 | 12.5 |
| | sizes | TD/ZD | | 10.0 | 9.5 | 19.2 | 10.5 | 10.9 | 12.8 | 12.1 | 9.1 | 10.0 | 10.0 | 9.0 | 9.0 |
| | Cell film thickness | | (μm) | 3 | 3 | 3 | 2 | 5 | 3 | 2 | 2 | 2 | 3 | 3 | 3 |
| | Cell size in ZD direction/ | | (—) | 6.0 | 6.7 | 4.0 | 10.0 | 2.2 | 6.0 | 9.5 | 11.0 | 9.5 | z | 6.7 | 6.7 |
| | Cell film thickness | | | | | | | | | | | | | | |
| | Compression | 25% | (kPa) | 50 | 70 | 35 | 28 | 95 | 55 | 22 | 65 | 75 | 40 | 45 | 39 |
| | strength | compression | | | | | | | | | | | | | |
| | | hardness | | | | | | | | | | | | | |
| | Tensile strength | MD | (MPa) | 11.6 | 10.9 | 10.7 | 6.2 | 13.0 | 10.2 | 7 | 6 | 10.7 | 9.7 | 12.1 | 12.3 |
| | | TD | (MPa) | 7.9 | 7.4 | 8.9 | 5.3 | 8.5 | 8.9 | 5.8 | 5.4 | 8.1 | 7.1 | 8.3 | 8.5 |

| | | | | | | | | | | | | | |
|---|---|---|---|---|---|---|---|---|---|---|---|---|---|
| Dropping ball shock strength | (J) | 0.098 | 0.216 | 0.080 | 0.053 | 0.107 | 0.098 | 0.053 | 0.080 | 0.107 | 0.089 | 0.116 | 0.134 |
| Evaluation of reworkability | (—) | ∘ | ∘ | ∘ | ∘ | ∘ | ∘ | ∘ | ∘ | ∘ | ∘ | ∘ | ∘ |
| Evaluation of punching processability | (—) | ∘ | ∘ | ∘ | ∘ | ∘ | ∘ | x | ∘ | ∘ | ∘ | ∘ | ∘ |

| | | | | Comparative Example | | | | | | | | | | |
|---|---|---|---|---|---|---|---|---|---|---|---|---|---|---|
| | Item | | Unit | 1 | 2 | 3 | 4 | 5 | 6 | 7 | 8 | 9 | 10 | 11 |
| Resin | LLDPE | | (—) | 50 | 50 | 50 | 50 | 50 | 50 | 50 | 100 | 0 | 50 | 50 |
| composition | LDPE | | (—) | 50 | 50 | 50 | 50 | 50 | 50 | 50 | 0 | 100 | 50 | 50 |
| | OBC | | (—) | 0 | 0 | 0 | 0 | 0 | 0 | 0 | 0 | 0 | 0 | 0 |
| Condition | Thickness of foamed sheet | | (mm) | 0.50 | 0.50 | 0.50 | 0.50 | 1.00 | 0.20 | 0.50 | 0.50 | 0.50 | 0.50 | 0.5 |
| of | before stretching | | | | | | | | | | | | | |
| stretching | Temperature of MD | | (° C.) | 105 | 105 | 105 | 105 | 105 | 105 | 97 | 105 | 105 | 105 | — |
| | stretching roll | | | | | | | | | | | | | |
| | Temperature of TD | | (° C.) | 125 | 125 | 125 | 125 | 125 | 125 | 118 | 125 | 125 | 130 | — |
| | stretching tenter | | | | | | | | | | | | | |
| | MD stretching ratio | | (%) | 200 | 200 | 200 | 200 | 290 | 130 | 200 | 200 | 200 | 200 | 100 |
| | TD stretching ratio | | (%) | 190 | 190 | 190 | 190 | 280 | 120 | 190 | 190 | 190 | 100 | 100 |
| Properties | Thickness | | (mm) | 0.10 | 0.10 | 0.10 | 0.10 | 0.10 | 0.10 | 0.10 | 0.10 | 0.10 | 0.20 | 0.50 |
| of foamed | Density | | (kg/m³) | 150 | 550 | 430 | 440 | 450 | 370 | 550 | 410 | 250 | 430 | 330 |
| sheet | Degree of cross-linking | | (%) | 35 | 35 | 25 | 55 | 35 | 35 | 35 | 21 | 40 | 35 | 35 |
| | Rate of closed cells | | (%) | 95 | 95 | 95 | 95 | 95 | 95 | 95 | 95 | 95 | 95 | 95 |
| | Thickness ratio of skin layer | | (%) | 11 | 25 | 9 | 24 | 19 | 22 | 23 | 7 | 22 | 20 | 20 |
| | Average | MD | (μm) | 300 | 220 | 310 | 160 | 340 | 200 | 250 | 280 | 260 | 240 | 180 |
| | cell size | TD | | 220 | 160 | 240 | 120 | 270 | 135 | 195 | 200 | 190 | 120 | 120 |
| | | ZD | | 20 | 16 | 20 | 11 | 15 | 28 | 15 | 25 | 21 | 19 | 80 |
| | | Average of | | 260 | 190 | 275 | 140 | 305 | 167.5 | 222.5 | 240 | 225 | 180 | 150 |
| | | MD and TD | | | | | | | | | | | | |
| | Ratio of | MD/ZD | (—) | 15.0 | 13.8 | 15.5 | 14.5 | 22.7 | 7.1 | 16.7 | 11.2 | 12.4 | 12.6 | 2.3 |
| | cell sizes | TD/ZD | | 11.0 | 10.0 | 12.0 | 10.9 | 18.0 | 4.8 | 13.0 | 8.0 | 9.0 | 6.3 | 1.5 |
| | Cell film thickness | | (μm) | 2 | 4 | 2 | 8 | 3 | 3 | 4 | 2 | 3 | 3 | 10 |
| | Cell size in ZD direction/ | | (—) | 10.0 | 4.0 | 10.0 | 1.4 | 5.0 | 9.3 | 3.8 | 12.5 | 7.0 | 6.3 | 8.0 |
| | Cell film thickness | | | | | | | | | | | | | |
| | Compression | 25% | (kPa) | 17 | 120 | 40 | 110 | 17 | 125 | 95 | 115 | 17 | 50 | 600 |
| | Strength | compression | | | | | | | | | | | | |
| | | hardness | | | | | | | | | | | | |
| | Tensile strength | MD | (MPa) | 4.5 | 14.2 | 10.2 | 13.6 | 12.9 | 7.4 | 14.9 | 10.4 | 5.9 | 9.4 | 4.7 |
| | | TD | (MPa) | 3.8 | 9.2 | 7.0 | 8.9 | 9.5 | 6.3 | 9.7 | 8.2 | 4.2 | 4.4 | 3.1 |

| | | | | | | | | | | | | |
|---|---|---|---|---|---|---|---|---|---|---|---|---|
| Dropping ball shock strength | (J) | 0.034 | 0.125 | 0.089 | 0.116 | 0.080 | 0.107 | 0.125 | 0.098 | 0.053 | 0.125 | 0.369 |
| Evaluation of reworkability | (—) | x | ∘ | ∘ | ∘ | ∘ | ∘ | ∘ | ∘ | x | x | x |
| Evaluation of punching | (—) | x | ∘ | x | ∘ | ∘ | ∘ | ∘ | x | ∘ | ∘ | ∘ |
| Processability | | | | | | | | | | | | |

### INDUSTRIAL APPLICABILITY

Our foamed sheets have excellent compression flexibility, reworkability and punching processability, and can be suitably used particularly when a cushioning material or a shock absorbing material is provided for electronic/electric equipment such as a mobile phone.

1-10. (canceled)

11. A polyolefin-based resin foamed sheet comprising a polyolefin-based resin, wherein a thickness of the foamed sheet is 0.05-0.5 mm, a 25% compression hardness defined in JIS K6767(1999) is 20-100 kPa, a ratio of cell sizes in longitudinal and thickness directions is 9-30, a ratio of cell sizes in width and thickness directions is 9-30, and an average cell film thickness in the thickness direction of the foamed sheet is 2-7 μm.

12. The polyolefin-based resin foamed sheet according to claim 11, wherein a value of a lower one among tensile strengths in the longitudinal direction and the width direction of the foamed sheet is 5 MPa to 10 MPa.

13. The polyolefin-based resin foamed sheet according to claim 11, wherein an average cell size in the thickness direction of the foamed sheet is 10-20 μm.

14. The polyolefin-based resin foamed sheet according to claim 11, wherein a ratio of an average cell size to an average cell film thickness in the thickness direction of the foamed sheet is 2-10.

15. The polyolefin-based resin foamed sheet according to claim 11, wherein an average cell size averaged with average cell sizes in the longitudinal direction and the width direction of the foamed sheet is 150-500 μm.

16. The polyolefin-based resin foamed sheet according to claim 11, wherein an apparent density of the foamed sheet is 200-500 kg/m³.

17. The polyolefin-based resin foamed sheet according to claim 11, wherein a degree of cross-linking of the foamed sheet is 30-50%.

18. The polyolefin-based resin foamed sheet according to claim 11, wherein a thickness ratio of a skin layer of the foamed sheet is 15-30%.

19. The polyolefin-based resin foamed sheet according to claim 11, that fixes by adhesion a component that forms an electronic/electric equipment to a main body of the equipment.

20. The polyolefin-based resin foamed sheet according to claim 12, that fixes by adhesion a component that forms an electronic/electric equipment to a main body of the equipment.

21. The polyolefin-based resin foamed sheet according to claim 13, that fixes by adhesion a component that forms an electronic/electric equipment to a main body of the equipment.

22. The polyolefin-based resin foamed sheet according to claim 14, that fixes by adhesion a component that forms an electronic/electric equipment to a main body of the equipment.

23. The polyolefin-based resin foamed sheet according to claim 15, that fixes by adhesion a component that forms an electronic/electric equipment to a main body of the equipment.

24. The polyolefin-based resin foamed sheet according to claim 16, that fixes by adhesion a component that forms an electronic/electric equipment to a main body of the equipment.

25. The polyolefin-based resin foamed sheet according to claim 17, that fixes by adhesion a component that forms an electronic/electric equipment to a main body of the equipment.

26. The polyolefin-based resin foamed sheet according to claim 18, that fixes by adhesion a component that forms an electronic/electric equipment to a main body of the equipment.
